(19) United States
(12) Patent Application Publication
(10) Pub. No.: US 2023/0142891 A1
(43) Pub. Date: May 11, 2023

(54) E-LEARNING SYSTEM AND E-LEARNING METHOD

(71) Applicant: GROWTH X INC., Shibuya-ku, Tokyo (JP)

(72) Inventor: Kotaro TSUKAMOTO, SHIBUYA-KU, TOKYO (JP)

(21) Appl. No.: 17/920,581

(22) PCT Filed: Jan. 13, 2022
(86) PCT No.: PCT/JP2022/000946

§ 371 Date: Oct. 21, 2022

(30) Foreign Application Priority Data
Feb. 8, 2021 (JP) 2021-018223

(51) Int. Cl. G09B 5/12; G09B 7/077

(52) U.S. Cl. CPC G09B 5/12; G09B 7/077

(57) ABSTRACT

There are provided an e-leaming system capable of maintaining motivation of a user and increasing an educational effect on the user, and the like. A server 2 of an e-learning system 1 acquires, from a plurality of terminals 3 and 4, learning qualities of users who use the terminals, and amounts of learning and replies to a questionnaire of the users, determines learning levels in accordance with the learning qualities and the amounts of learning of the users, and determines a priority order of the replies to the questionnaire in accordance with the learning levels. In the terminal 3, a plurality of replies to the questionnaire are displayed on a display 33 in correspondence to the priority order.

### TECHNICAL FIELD

The present invention relates to an e-leaming system in which users attend courses via terminals, and the like.

### BACKGROUND ART

Conventionally, an e-learning system as described in Patent Literature 1 has been known, and this e-learning system includes a server and a user terminal.

In the case of this e-learnig system, a user views a course of e-learning content offered from the server on the user terminal, and takes a test after viewing. Then, a result of replies when taking the test is sent from the user terminal to the server. The result of replies is scored in the server, and then pass/fail of the test is sent to the user terminal. Then, the user takes the test again if a scoring result of the test is a failure. The user attends each course of e-learing while repeating the above process.

### CITATION LIST

### Patent Literature

Patent Literature 1: Japanese Patent Laid-Open No. 2020-101959

### SUMMARY OF INVENTION

### Technical Problem

In general, it is desired that e-learning should increase an educational effect for a user while maintaining motivation of the user. In contrast, in the above-described conventional e-learning system, a user only receives a scoring result of the test after attending a course, which leads to a decrease in motivation of the user for e-learning. This results in a problem in that the educational effect for the user cannot be increased.

The present invention has been made to solve the above-described problems, and has an object to provide an e-learning system that can maintain motivation of a user and increase an educational effect on the user, and the like.

### Solution to Problem

In order to achieve the above-described object, an invention according to claim 1 is an e-learning system including an arithmetic processing device and a plurality of terminals that are able to communicate with the arithmetic processing device via a network, e-learning content including a plurality of subjects being offered from the arithmetic processing device to the plurality of terminals used by a plurality of respective users, the e-learning system including an acquisition unit provided in the arithmetic processing device, the acquisition unit being configured to acquire a learning quality indicating a quality of learning of the e-learning content of an individual terminal user who is each of the respective users using the plurality of terminals, an amount of learning of the e-learning content of the individual terminal user, and item information including at least one of a reply of the individual terminal user to a questionnaire related to any single subject among the plurality of subjects in the e-learning content and conducted when the single subject is terminated, an opinion of the individual terminal user about the single subject, and an impression of the individual terminal user about the single subject, a priority order determination unit provided in one of the arithmetic processing device and each of the terminals, the priority order determination unit being configured to determine a priority order of the item information in accordance with the learning quality and the amount of learning of the individual terminal user acquired by the acquisition unit, and a display control unit provided in each of the terminals, the display control unit being configured to execute display control of displaying the item information determined by the priority order determination unit on a display unit of each of the terminals in correspondence to the priority order.

With this e-learning system, display control is executed by the display control unit of each of the terminals. Since this display control is to display the item information on the display unit of each of the terminals in correspondence to the priority order, a user of each of the terminals is able to refer to the item information of the other users in correspondence to the priority order.

Herein, the priority order of the item information is determined in accordance with the learning quality indicating the quality of learning of the e-learning content of the individual terminal user and the amount of learning of the e-learning content of the individual terminal user. This enables item information close to the learning level of each user, item information effective for making learning of each user efficient, and the like, for example, to be displayed preferentially during execution of the above-described display control.

Further, this item information includes at least one of a reply of the individual terminal user to a questionnaire related to any single subject among the plurality of subjects in the e-learning content and conducted when the single subject is terminated, an opinion of the individual terminal user about the single subject, and an impression of the individual terminal user about the single subject. In other words, the item information includes such items for which each user outputs content that he/she has learned.

Therefore, in a case of displaying the item information based on the priority order as described above, each user is able to refer to items outputted in relation to learned content by users having learning levels close to the learning level of each user himself/herself and users having levels that they may have a favorable influence on each other. In other words, each user is able to refer to understanding, insights, and the like of users except each user himself/herself about the subject.

Consequently, each user is able to maintain or improve his/her own willingness to learn, and deepen his/her understanding about content of the subject. In other words, motivation of each user can be maintained, and the educational effect on each user can be increased.

In an invention according to claim 2, in the e-learning system according to claim 1, the item information displayed on the display unit during execution of the display control is the item information of the users except a terminal user who is each of the users using the terminals, learning levels of the users except the terminal user determined based on the learning quality and the amount of learning falling within a predetermined range with respect to the learning level of the terminal user.

With this e-learning system, by setting the predetermined range at a range close to the learning level of a terminal user, for example, the terminal user is able to refer to the item information of users having learning levels close to the learning level of the terminal user himself/herself during execution of the display control. This enables the terminal user to further deepen understanding and an insight about the subject as compared with a case of referring to item information of users having learning levels far from the learning level of the terminal user himself/herself, which can further improve the educational effect.

In an invention according to claim 3, in the e-learing system according to claim 1, the item information displayed on the display unit during execution of the display control is the item information of the users except a terminal user who is each of the users using the terminals, learning levels of the users except the terminal user determined based on the learning quality and the amount of learning being equal to or higher than the learning level of the terminal user.

With this e-learning system, since the item information is set at a range of learning levels equal to or higher than the learning level of the terminal user, the terminal user is able to refer to item information of users having learning levels equal to or higher than the learning level of the terminal user himself/herself during execution of the display control. This enables the terminal user to refer to understanding, insights, and the like which are more helpful than in a case of referring to item information of users having learning levels lower than the learning level of the terminal user himself/herself, which can further improve the educational effect.

In an invention according to claim 4, in the e-learning system according to claim 1, the terminals are configured such that when an input unit of each of the terminals is operated by a terminal user who is each of the users using the terminals during execution of the display control, rating data including at least one of a comment of the terminal user on the item information of the users except the terminal user, a low rating, and a high rating can be entered, and the priority order determination unit determines the priority order of the item information further in accordance with a total number of pieces of the rating data about the item information.

In the case where the rating data is defined as at least one of a comment of a terminal user on item information of users except the terminal user, a low rating, and a high rating as in this e-learning system, a large total number of pieces of rating data about the item information represents a state in which at least one of high interest of other users, high ratings given by the other users, and low ratings given by the other users, about the item information, is frequent.

Therefore, in the case of determining the priority order of the item information further in accordance with the total number of pieces of rating data about the item information, the item information being in the state as described above can be displayed more preferentially on the display unit. This allows the terminal user to refer to more preferentially item information being in a state in which at least one of high interest of the other users, high ratings given by the other users, and low ratings given by the other users is more frequent. As a result, maintenance of motivation of the user for e-learning and improvement of the educational effect can be achieved.

In an invention according to claim , in the e-learning system according to claim 1, the terminals are configured such that when an input unit of each of the terminals is operated by a terminal user who is each of the users using the terminals during execution of the display control, rating data including at least one of a comment of the terminal user on the item information of the users except the terminal user, a high rating, and a low rating can be entered, and a total number of pieces of the rating data entered by the plurality of users including the terminal user is displayed.

With this e-learning system, the total number of pieces of rating data about the item information entered by a plurality of users including a terminal user is displayed during execution of the display control. Since this rating data is at least one of a comment of the terminal user, a low rating, and a high rating, the user is able to recognize at least one of item information in which the other users are more interested, item information given a larger number of high ratings by the other users, and item information given a larger number of low ratings by the other users. Further, the user is able to compare such item information with his/her own item information. As a result, maintenance of motivation of the user for e-learning and improvement of the educational effect can be achieved.

An invention according to claim 6 is an e-learning method for offering e-learning content including a plurality of subjects from an arithmetic processing device to a plurality of terminals used by a plurality of respective users via a network, in which the arithmetic processing device executes communication with each of the plurality of terminals via the network to perform acquisition of a learning quality indicating a quality of learning of the e-learning content of an individual terminal user who is each of the respective users using the terminals, an amount of learning of the e-learning content of the individual terminal user, and item information including at least one of a reply of the individual terminal user to a questionnaire related to any single subject among the plurality of subjects in the e-learning content and conducted when the single subject is terminated, an opinion of the individual terminal user about the single subject, and an impression of the individual terminal user about the single subject, one of the arithmetic processing device and each of the terminals determines a priority order of the item information in accordance with the learning quality and the amount of learning of the individual terminal user having been obtained by the acquisition, and each of the terminals displays the item information in correspondence to the priority order.

### BRIEF DESCRIPTION OF DRAWINGS

FIG. 1 is a diagram schematically showing a configuration of an e-learning system according to an embodiment of the present invention.

FIG. 2 is a block diagram showing a functional configuration of a server.

FIG. 3 is a block diagram showing a functional configuration of a terminal.

FIG. 4 is a diagram showing an example of content of e-learning.

FIG. 5 is a sequential diagram showing various types of control processing and the like during e-learning.

FIG. 6 is a flowchart showing learning control processing.

FIG. 7 is a flowchart showing various types of computing processing.

FIG. 8 is a diagram showing an example of a questionnaire screen.

FIG. 9 is a diagram showing an example of a reply list screen.

### DESCRIPTION OF EMBODIMENT

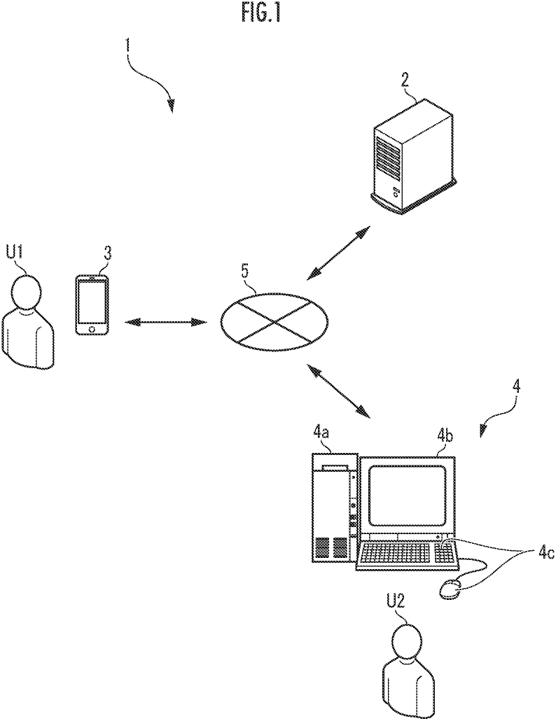

Hereinafter, an e-learning system according to an embodiment of the present invention will be described with reference to the drawings. As shown in FIG. 1, an e-learning system 1 of the present embodiment includes a server 2, a plurality of terminals 3 (only one of them is shown), and a plurality of terminals 4 (only one of them is shown).

The server 2 and the terminals 3, 4 are connected via a network 5 so as to be able to communicate with each other, and the network 5 is composed of the Internet, a LAN, and the like.

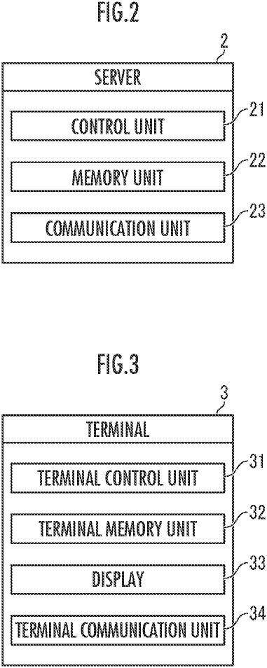

First, the server 2 will be described. The server 2 includes a control unit 21, a memory unit 22, and a communication unit 23 as shown in FIG. 2. The control unit 21 is composed of a CPU, a memory, an I/O interface, and the like, and executes various types of control processing and various types of computing processing which will be described later. In the present embodiment, the server 2 is equivalent to an arithmetic processing device, and the control unit 21 is equivalent to acquisition unit and a priority order determination unit.

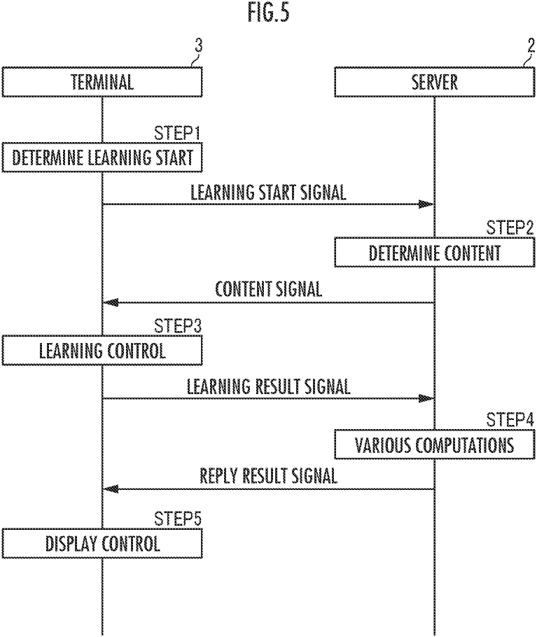

The memory unit 22 is composed of a memory device such as ROM, RAM, or HDD, for example, and stores a program for e-learning, e-learing content (see FIG. 4 which will be described later), data indicating a learning state of each user, computation results obtained by the control unit 21, and the like. The data indicating a learning state of each user is received by the communication unit 23 through communication with the terminal 3 or 4, and stored in the memory unit 22 as will be described later.

The communication unit 23 is composed of a communication device, and executes communication with an external instrument such as the terminal 3 or 4 via the network 5.

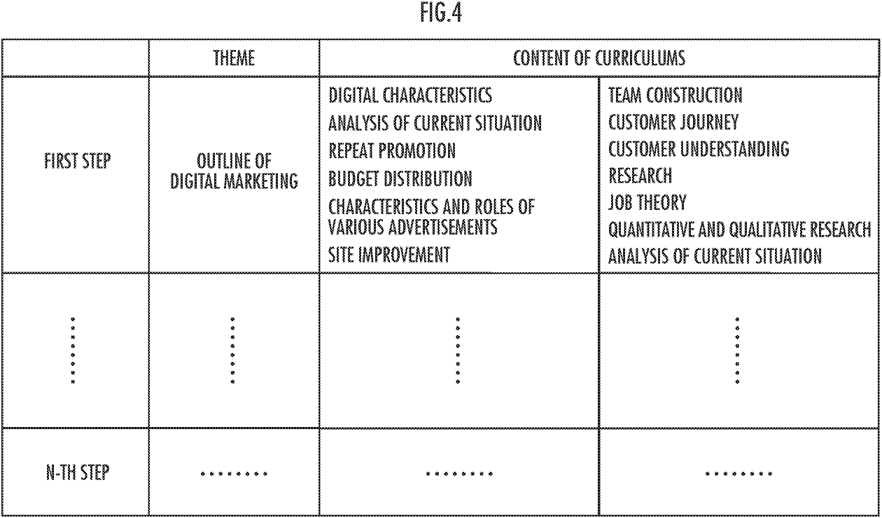

Next, the terminal 3 will be described. The terminal 3 is of a smartphone type and is used by a user U1. The terminal 3 includes a terminal control unit 31, a terminal memory unit 32, a display 33, and a terminal communication unit 34 as shown in FIG. 3.

The terminal control unit 31 is composed of a CPU, a memory, an I/O interface, and the like, and executes various types of control processing during execution of e-learning.

In the present embodiment, the terminal control unit 31 is equivalent to a display control unit.

The terminal memory unit 32 is composed of a memory device such as E2PROM and RAM, for example. This terminal memory unit 32 stores results of computing processing obtained by the terminal control unit 31, data received by the terminal control unit 31 via the terminal communication unit 34 (for example, e-learning content), an installed program for attending e-learning courses, a user ID for identifying the user U1 of the terminal 3, and the like.

The display 33 is composed of a capacitance-type touch panel, which is arranged across substantially a large part of a front surface of the terminal 3 and is electrically connected to the terminal control unit 31. The terminal control unit 31 controls a display state of the display 33 while the program for attending e-learning courses is being executed, to thereby execute display control processing, as will be described later.

In addition, the terminal control unit 31 is configured to recognize the mode of a touch operation on the display 33 made by the user U1. In this case, the touch operation includes operations such as taps (a single tap, double taps, and a long tap), flicks (an upward flick, a downward flick, a leftward flick, and a rightward flick), swipe, pinch (pinch-in and pinch-out), or a multi-touch. In the present embodiment, the display 33 is equivalent to a display unit and an input unit.

The terminal communication unit 34 is composed of a communication device, and executes communication with an external instrument such as the server 2 via the network 5 during execution of e-learning.

Next, the terminal 4 will be described. The terminal 4 is of a desktop personal computer type, and is used by a user U2. The terminal 4 includes a terminal main body 4a, a display 4b, and an input interface 4c as shown in FIG. 1.

This terminal main body 4a has a microcomputer, a storage, and a communication device (neither shown) built therein. The microcomputer is composed of a CPU, a memory, an I/O interface, and the like. The storage is composed of HDD, SDD, or the like.

This storage stores results of computing processing obtained by the microcomputer, data received by the microcomputer via the communication device (for example, e-learning content), an installed program for attending e-learning courses, a user ID for identifying the user U2 of the terminal 4, and the like.

The microcomputer controls a display state of the display 4b while the program for attending e-learning courses is being executed, to thereby execute display control processing. Further, the input interface 4c is composed of a keyboard, a mouse, and the like for operating the terminal 4. Various types of data are entered to the terminal 4 in association with an operation of the input interface 4c made by the user U2 while the program for attending e-learning courses is being executed.

Next, a learning method in the e-learning system of the present embodiment will be described. Hereinafter, a case in which the user U1 uses the terminal 3 to execute e-learning of a digital marketing course will be described as an example.

In the case of the present embodiment, content shown in FIG. 4 is used as e-learning content. This e-learning content includes N steps from the first step to the N-th (N is an integer) step, and a theme and many curriculums are set for each step. In the present embodiment, a curriculum is equivalent to a subject.

In other words, “OUTLINE OF DIGITAL MARKETING” is set as the theme of the first step, and fourteen types from “DIGITAL CHARACTERISTICS” to “ANALYSIS OF CURRENT SITUATION” are set as content of the curriculums.

In this e-learning system, the user U1 attends a curriculum using the terminal 3, and then takes a test related to the curriculum, as will be described later. Then, after taking this test, a questionnaire related to the curriculum is displayed on the display 33 of the terminal 3. The user U1 is able to refer to comments of other users by replying to this questionnaire while making a touch operation on the display 33 as will be described later.

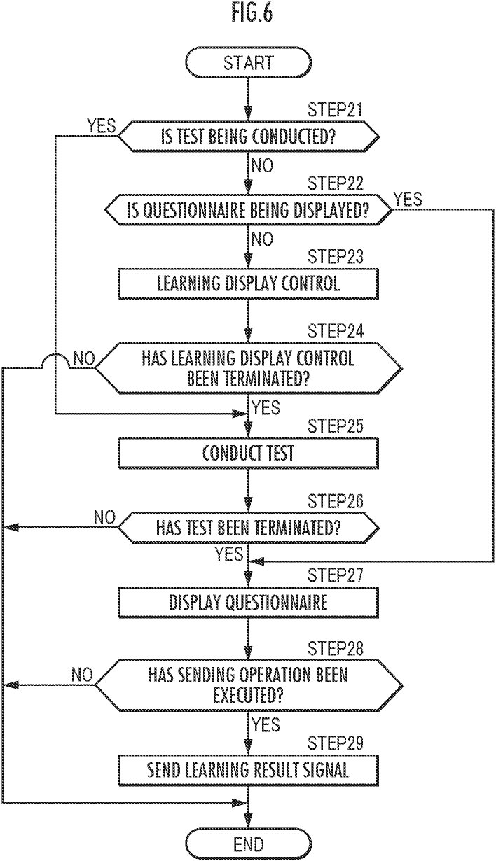

Next, various types of control processing to be executed during e-learning in the e-learning system 1 will be described with reference to FIG. 5. FIG. 5 is an example of a case in which e-learning is executed in the terminal 3 of the user U1. In addition, the control processing in FIG. 5 is performed after the program for attending e-learning courses is executed by an operation on the terminal 3 made by the user U1 and the user U1 has logged in the system of the server 2.

As shown in FIG. 5, first, learning start determination processing is executed in the terminal 3 (STEP1 in FIG. 5). This learning start determination processing is to determine whether or not a learning start operation of the user U1 has been executed, and specifically is conducted as will be described below.

In other words, when the user U1 selects a curriculum that he/she wishes to attend from a list of curriculums (not shown) displayed on the display 33 and then presses down a start button not shown during execution of the program for attending e-learning courses in the terminal 3, it is determined that the learning start operation of the user U1 has been executed, and otherwise, it is determined that the learning start operation has not been executed.

In the case where the start button is pressed down by the user U1, a learning start signal indicating the curriculum that the user U1 wishes to attend is sent from the terminal 3 to the server 2.

In a case where this learning start signal is received by the server 2, content determination processing is executed in the server 2 (STEP2 in FIG. 5). In this content determination processing, content of the curriculum of e-learning to be offered to the user U1 is determined based on the learning start signal. Then, a content signal including such content is sent from the server 2 to the terminal 3.

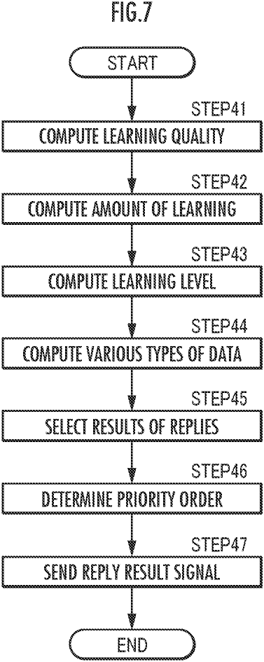

In a case where this content signal is received by the terminal 3, learning control processing is executed in the terminal 3 (STEP3 in FIG. 5). This learning control processing is specifically executed in the terminal 3 in a predetermined control cycle as shown in FIG. 6.

As shown in FIG. 6, it is first determined whether or not a test is being conducted (STEP21 in FIG. 6). This test is conducted after a curriculum is terminated as will be described later.

When this determination is affirmative (YES in STEP21 in FIG. 6) and the test is being conducted, the process proceeds into test conducting processing (STEP25 in FIG. 6) which will be described later.

When this determination is negative (NO in STEP21 in FIG. 6) and the test after the curriculum is terminated is not being conducted, it is determined whether or not a questionnaire is being displayed (STEP22 in FIG. 6). This questionnaire is displayed after the test is terminated as will be described later.

When this determination is affirmative (YES in STEP22 in FIG. 6) and the questionnaire is being displayed, the process proceeds into questionnaire display processing (STEP27 in FIG. 6) which will be described later. When this determination is negative (NO in STEP22 in FIG. 6) and the questionnaire is not being displayed, learning display control processing is executed (STEP23 in FIG. 6).

In this learning display control processing, the content of the curriculum included in the aforementioned content signal is reproduced and displayed on the display 33 although not shown. This enables the user U1 to attend the curriculum.

Then, it is determined whether or not the learning display control processing has been terminated (STEP24 in FIG. 6). In this case, when the content of the curriculum is reproduced and displayed to the last and a termination operation is then conducted by the user U1, it is determined that the learning display control processing has been terminated, and otherwise, it is determined that the learning display control processing has not been terminated.

When this determination is negative (NO in STEP24 in FIG. 6) and the learning display control processing is not yet terminated, the present process is directly terminated. When this determination is affirmative (YES in STEP 24 in FIG. 6) and the learning display control processing is terminated, the test is conducted (STEP25 in FIG. 6).

This test is for testing the level of understanding of the user U1 about the curriculum, and the like. In the description below, a time period required for the user U1 to answer test questions will be referred to as an “answering time period”.

Then, it is determined whether or not the test has been terminated (STEP26 in FIG. 6).

In this case, when the user U1 enters all answers to the test and then conducts the termination operation, it is determined that the test has been terminated, and otherwise, it is determined that the test has not been terminated.

When this determination is negative (NO in STEP26 in FIG. 6) and the test is not yet terminated, the present process is directly terminated. When this determination is affirmative (YES in STEP26 in FIG. 6) and the test is terminated, the questionnaire display processing is executed (STEP27 in FIG. 6).

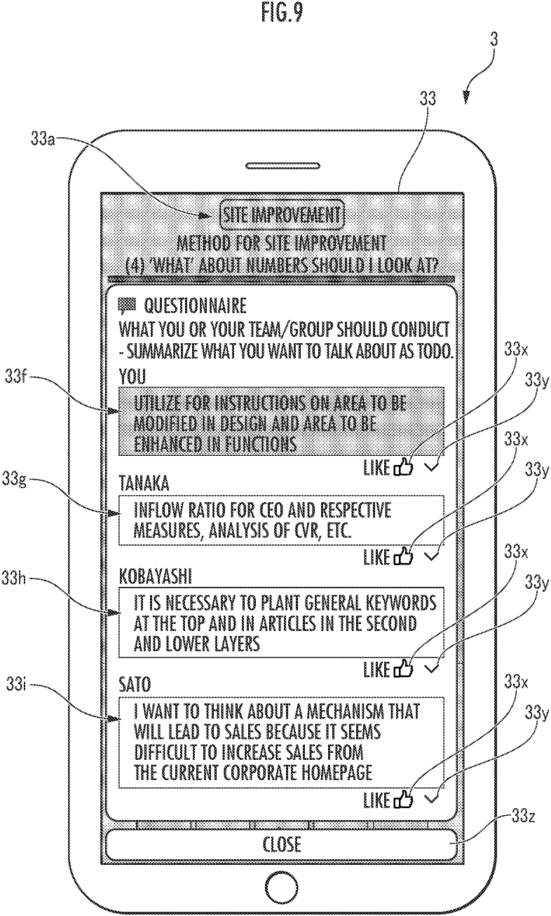

In this questionnaire display processing, a questionnaire screen as shown in FIG. 8 is displayed on the display 33 of the terminal 3. In the case of this questionnaire screen, a point of the curriculum and text about specific content of the point are displayed in a display region 33a at the top of the screen. In the example shown in FIG. 8, the item of the curriculum of “SITE IMPROVEMENT” and text that “METHOD FOR SITE IMPROVEMENT, (4) ‘WHAT’ ABOUT NUMBERS SHOULD I LOOK AT?” are displayed.

Further, in order to conduct a questionnaire to the user U1 having attended the above-described curriculum, a message indicating content of the questionnaire is displayed in a questionnaire display field 33b below the display region 33a. In the example shown in FIG. 8, a message that “WHAT YOU OR YOUR TEAM/GROUP SHOULD CONDUCT - SUMMARIZE WHAT YOU WANT TO TALK ABOUT AS TODO” is displayed.

Further, in order to prompt a reply to the questionnaire, a message that “YOU CAN CHECK EVERYONE’S REPLY AFTER YOU REPLY” is displayed below the questionnaire display field 33b, and a message indicating the number of users having already replied (in the example shown in FIG. 8, a message that “EIGHT PEOPLE HAVE REPLIED”) is displayed.

Further, a reply write-in field 33c and a send button 33d are displayed below the questionnaire field 33b. This reply write-in field 33c is for the user U1 to enter a reply to the questionnaire, and the send button 33d is for the user U1 to send the reply to the questionnaire to the server 2.

When the user U1 taps the inside of the reply write-in field 33c, an entry keyboard 33e is displayed below the reply write-in field 33c. This enables the user U1 to operate this entry keyboard 33e to thereby enter a reply to the questionnaire in the questionnaire field 33b. In the example shown in FIG. 8, a reply that “UTILIZE FOR INSTRUCTIONS ON AREA TO BE MODIFIED IN DESIGN AND AREA TO BE ENHANCED IN FUNCTIONS” has been entered.

In the description below, the questionnaire to which the user U1 has entered a reply after the present curriculum is terminated will be referred to as a “present questionnaire”. In addition, in the present embodiment, a reply to the questionnaire is equivalent to item information.

Then, it is determined whether or not a sending operation has been executed (STEP28 in FIG. 6). In this case, when the send button 33d described above is pressed down by the user U1, it is determined that the sending operation has been executed, and otherwise, it is determined that the sending operation has not been executed.

When this determination is negative (NO in STEP28 in FIG. 6) and the sending operation is not yet executed, the present process is directly terminated. When this determination is affirmative (YES in STEP28 in FIG. 6) and the sending operation is executed, processing of sending a learning result signal is executed (STEP29 in FIG. 6). By execution of this sending processing, the learning result signal is sent to the server 2.

This learning result signal includes, as a learning result, ID of the user U1, a result of answers (a percentage of correct answers and an answering time period) of the user U1 to test questions after the present curriculum is terminated, and a result of a reply to the present questionnaire. As described above, the present process is terminated after the learning result signal is sent.

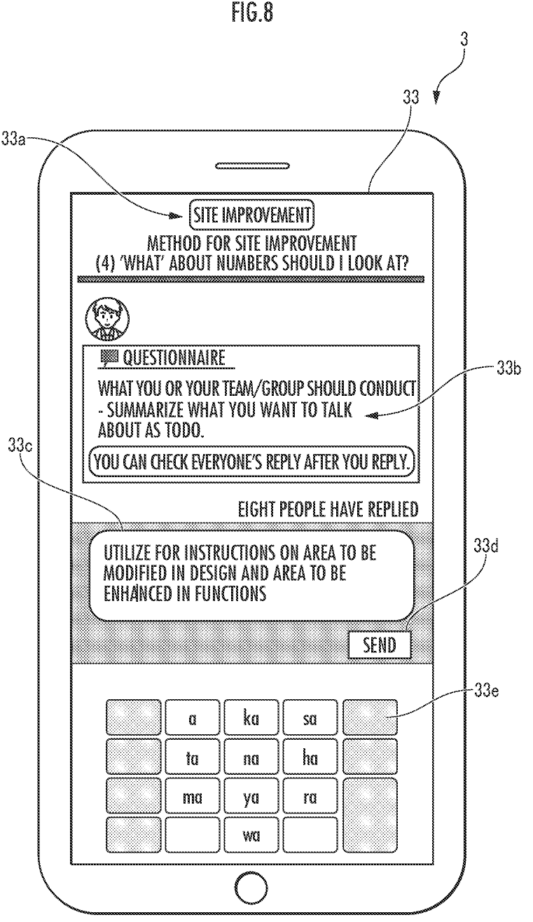

Referring back to FIG. 5, in a case where this learning result signal is received by the server 2, various types of computing processing are executed in the server 2 (STEP4 in FIG. 5). The various types of computing processing are to conduct computations of various types of data and the like, and are specifically executed as shown in FIG. 7.

As shown in FIG. 7, first, processing of computing a learning quality is executed (STEP41 in FIG. 7). This learning quality indicates the quality of learning of the user U1 in e-learning, and is specifically computed by a technique which will be described below.

First, an average value of percentages of correct answers (hereinafter referred to as an “average percentage of correct answers”) of the user U1 is computed using the percentage of correct answers in the result of answers in the present test and the percentage of correct answers in a previous test of the user U1.

Then, an average value of answering time periods (hereinafter referred to as an “average answering time period”) of the user U1 is computed using the answering time period in the present test and the answering time period in the previous test. Then, the learning quality is computed by searching through a map not shown in accordance with the average percentage of correct answers and the average answering time period. In this case, the learning quality is computed as a larger value as the average percentage of correct answers is higher or as the average answering time period is shorter.

Instead of the above-described technique, the learning quality may be computed by a technique of substituting the average percentage of correct answers and the average answering time period into a predetermined arithmetic expression. Also in that case, the learning quality is computed as a larger value as the average percentage of correct answers is higher or as the average answering time period is shorter.

Then, processing of computing an amount of learning is executed (STEP42 in FIG. 7). This amount of learning is computed as a progression rate of the user U1 relative to all curriculums at a time point when the present curriculum is terminated.

The amount of learning is not limited to the progression rate of the user U1 relative to all the curriculums, but may be the total sum of attending time periods in curriculums that the user U1 has attended so far. Alternatively, the amount of learning may be calculated by performing a weighted average computation on the attending time periods in a plurality of curriculums that the user U1 has attended so far.

Next, processing of computing a learning level is executed (STEP43 in FIG. 7). This learning level is calculated by searching through a map not shown in accordance with the learning quality and the amount of learning described earlier. In this case, the learning level is computed as a larger value as the learning quality is higher or as the amount of learning is larger.

The learning level may be computed as a product of the learning quality and the amount of learning instead of the above-described technique.

After executing the processing of computing the learning level as described above, processing of storing various types of data is executed (STEP44 in FIG. 7). In the storing processing, various types of data, such as the learning level of the user U1 having been computed as described above and the result of a reply to the questionnaire, are stored in the memory unit 22.

As a result, learning levels, results of replies to questionnaires, and the like of many users including the user U1 are stored in the memory unit 22 as data of the many users. In the description below, users except the user U1 will be referred to as “other users”.

Then, processing of selecting results of replies is executed (STEP45 in FIG. 7). In this selection processing, first, results of replies of other users having learning levels that fall within a predetermined range with respect to the learning level of the user U1 are selected from among results of replies of the other users to the present questionnaire among results of replies to questionnaires stored in the memory unit 22.

This predetermined range is set as a range having a lower limit value obtained by multiplying the learning level of the user U1 and a predetermined value α (for example, a value of 0.95) and an upper limit value obtained by multiplying the learning level of the user U1 and a predetermined value β (for example, a value of 1.1), for example. In other words, results of replies of other users having learning levels that fall within a range close to the learning level of the user U1 are selected. The upper limit value and the lower limit value of the predetermined range are not limited to the above-described values, but the predetermined range should only have such values that the learning levels of the other users fall within a range close to the learning level of the user U1.

Next, processing of determining a priority order is executed (STEP46 in FIG. 7). This determination processing is to determine the priority order of the other users in the results of replies selected in the above-described selection processing based on the learning levels of the other users. Specifically, the priority order is determined such that another user having a higher learning level is given higher priority.

In other words, another user having the highest learning level is determined as having “the first” priority. Another user having the second highest learning level is determined as having “the second” priority, and another user having the lowest learning level is determined as having “the lowest” priority.

Then, processing of sending a reply result signal is executed (STEP47 in FIG. 7). By execution of this sending processing, the reply result signal is sent to the terminal 3. This reply result signal includes the results of replies of the other users to the present questionnaire selected as described above and the priority order of the other users. As described above, the present process is terminated after the reply result signal is sent to the terminal 3.

Referring back to FIG. 5, in a case where this reply result signal is received by the terminal 3, display control processing is executed in the terminal 3 (STEP5 in FIG. 5). In this display control processing, a reply list screen as shown in FIG. 9 is displayed on the display 33 of the terminal 3.

In the case of this reply list screen, a point of a curriculum and text about specific content of the point are displayed in the display region 33a at the top of the screen, and a message indicating content of a questionnaire is displayed in the questionnaire field 33b below the display region 33a.

In addition, content of a reply to the present questionnaire that the user U1 has entered is displayed in a display region 33f below the questionnaire field 33b. In the example shown in FIG. 9, content identical to the content in the example of the questionnaire screen in FIG. 8 is displayed in the display region 33a, the questionnaire field 33b, and the display region 33f.

Further, three display regions 33g to 33i are set in descending order below the display region 33f. Replies to the present questionnaire of the other users ranked first to third in the priority order (hereinafter referred to as “replies to the questionnaire of the other users”) as described earlier are displayed in these display regions 33g to 33i together with the names of the other users.

In addition, by scrolling the reply list screen downward, replies to the questionnaire of other users ranked fourth and lower in the priority order are also displayed in the display region in the screen together with the names of the other users, although not shown.

In other words, during execution of the display control processing, a reply of another user having the highest learning level in the results of replies of the other users having learning levels that fall within a range close to the learning level of the user U1 is displayed at the top, and the remaining results of replies are displayed on the lower side as the learning levels of the other users are lower.

In addition, a like button 33x and a pull-down menu button 33y are displayed at the lower right side of each of the four display regions 33f to 33i. Further, these two buttons 33x and 33y are also displayed in display regions of replies to the questionnaire of the other users ranked fourth and lower in the priority order when the reply list screen is scrolled downward.

In a case where the user U1 rates any of comment replies high when referring to the comment replies in the display regions 33g to 33i or referring to replies while scrolling the reply list screen downward, the user U1 is able to show that he/she has rated the comment reply high by pressing down the like button 33x. In this manner, in the case where the like button 33x is pressed down, a signal to that effect is sent from the terminal 3 to the server 2 although not shown.

In a case where the user U1 presses down the pull-down menu button 33y, a comment write-in field and a send button similar to the reply write-in field 33c and the send button 33d in FIG. 8 described earlier are displayed (not shown).

When the user U1 taps the inside of the comment write-in field, an entry keyboard similar to the entry keyboard 33e in FIG. 8 described earlier is displayed below the comment write-in field (not shown). This enables the user U1 to enter a comment to a reply to the questionnaire of another user in the comment write-in field by operating this entry keyboard.

In this manner, in the case where a comment to a reply to the questionnaire of another user is entered by the user U1 in the comment write-in field, a signal to that effect is sent from the terminal 3 to the server 2 although not shown.

In addition, a close button 33z is displayed in the lowest region of the reply list screen, and the user U1 is able to terminate the reply list screen by pressing down this close button 33z.

In the case of the e-learning system 1 of the present embodiment, various types of control processing are executed in the terminal 3 of the user U1, and communication with the server 2 is executed as described above, so that e-learning is executed. The same applies to the terminals 3 and 4 except the terminal 3 used by the user U1.

As described above, according to the e-learning system 1 of the present embodiment, the display control processing (STEP5 in FIG. 5) is executed after the learning control processing is terminated in the terminal 3 of the user U1. In this display control processing, replies to the questionnaire of the other users having learning levels that fall within a range close to the learning level of the user U1 are displayed on the display 33 in correspondence to the priority order.

Herein, the priority order of the replies to the questionnaire is determined in accordance with the learning qualities and the amounts of learning of the other users. Therefore, this enables replies to the questionnaire close to the learning level of the user U1, replies to the questionnaire effective for making learning of the user U1 efficient, and the like to be displayed preferentially during execution of the above-described display control processing.

Further, these replies to the questionnaire include, in relation to a single curriculum in e-learning content, at least one of an item that the other users consider should be conducted and an item for which an opinion or an impression of a user other than the other users is desired. In other words, the replies to the questionnaire include such an item for which the other users output content they have learned.

Therefore, in the case of displaying the replies to the questionnaire in correspondence to the priority order as described above, the user U1 is able to refer to such items for which the other users having learning levels close to the learning level of the user U1 himself/herself and the other users having levels that they may have a favorable influence on each other output content they have learned.

This enables each user to further deepen understanding and an insight about the curriculum as compared with a case of referring to item information of users having learning levels far from his/her own learning level, which can further improve the educational effect.

Consequently, the respective users including the user U1 are able to maintain or improve their own willingness to learn to deepen their own understanding about content of the curriculum. In other words, motivation of each user can be maintained, and the educational effect on each user can be increased.

In the e-learning system 1 according to the embodiment, the display control processing (STEP 5 in FIG. 5) may be executed as will be described below. In the description below, users who utilize the e-learning system 1 including the users U1 and U2 will be referred to as “utilizing users”.

First, in the reply list screen shown in FIG. 9, a dislike button (not shown) is displayed at the lower right side of each of the display regions 33f to 33i for replies to the questionnaire, in addition to the like button 33x and the pull-down menu button 33y. This dislike button is for indicating that the user U1 has rated a reply to the questionnaire of another user low.

Then, the total number of comments on a reply to the questionnaire, the total number of utilizing users having pressed down the like button 33x, and the total number of utilizing users having pressed down the dislike button are displayed in each of the display regions 33f to 33i for the replies to the questionnaire. In other words, the total number of users having entered comments on a reply to the questionnaire, the total number of users having rated the reply to the questionnaire high, and the total number of users having rated the reply to the questionnaire low are displayed.

In the case of the configuration as described above, a user is able to recognize, during execution of the display control processing, a reply to the questionnaire in which the other users are more interested, a reply to the questionnaire given a larger number of high ratings by the other users, or a reply to the questionnaire given a larger number of low ratings by the other users. Further, the user is able to compare such a reply to the questionnaire with his/her own reply to the questionnaire. As a result, maintenance of motivation of the user for e-learning and improvement of the educational effect can be achieved.

At least one of the total number of comments on a reply to the questionnaire, the total number of utilizing users having pressed down the like button 33x, and the total number of utilizing users having pressed down the dislike button may be displayed on the reply list screen shown in FIG. 9. Further, the total number of utilizing users having pressed down one of the like button 33x and the dislike button may be displayed together with display of one of the like button 33x and the dislike button.

In addition, the following control processing may be executed in the e-learning system 1 according to the embodiment. First, when the like button 33x and the above-described dislike button are pressed down, the terminal 3 sends a signal to that effect to the server 2. In addition, when a comment on a reply to the questionnaire is entered, the terminal 3 sends a signal including the comment to the server 2.

Then, based on the above-described signal, the server 2 computes the total number of pieces of rating data which is the total sum of the total number of utilizing users having rated the reply to the questionnaire high, the total number of users having rated the reply to the questionnaire low, and the total number of comments of utilizing users on the reply to the questionnaire.

Then, in the processing of determining the priority order (STEP 46 in FIG. 7), the priority order is determined in accordance with the learning levels of the other users and the total number of pieces of rating data about replies to the questionnaire of the other users. At that time, in a case where there are a plurality of users having the same learning level, a determination is made that a user having a large total number of pieces of rating data is given higher priority than a user having a small total number of pieces of rating data.

In the case of the configuration as described above, a large total number of pieces of rating data about a reply to the questionnaire represents a state in which at least one of high interest of the other users in the reply to the questionnaire, high ratings of the reply to the questionnaire given by the other users, and low ratings of the reply to the questionnaire given by the other users is frequent.

Therefore, in the case of determining the priority order of the replies to the questionnaire further in accordance with the total number of pieces of rating data about the replies to the questionnaire, a reply to the questionnaire being in the state as described above can be displayed more preferentially on the display 33. This allows the user U1 of the terminal 3 to refer to more preferentially a reply to the questionnaire being in a state in which at least one of high interest of the other users, high ratings of the reply to the questionnaire given by the other users, and low ratings of the reply to the questionnaire given by the other users is more frequent. As a result, maintenance of motivation of the user for e-learning and improvement of the educational effect can be achieved.

In the foregoing, the total number of pieces of rating data may be any one of the total number of utilizing users having rated a reply to the questionnaire high, the total number of users having rated the reply to the questionnaire low, and the total number of comments of utilizing users on the reply to the questionnaire. Further, the total number of pieces of rating data may be the sum of any two of the total number of utilizing users having rated the reply to the questionnaire high, the total number of users having rated the reply to the questionnaire low, and the total number of comments of utilizing users on the reply to the questionnaire.

Although the embodiment is an example in which the results of replies to the questionnaire of the other users having learning levels that fall within a predetermined range with respect to the learning level of the user U1 are displayed on the display 33 during execution of the display control processing (STEP 5), instead of this, the results of replies to the questionnaire of the other users having learning levels equal to or higher than the learning level of the user U1 may be displayed on the display 33.

In the case of such a configuration, the user U1 is able to refer to replies to the questionnaire of users having learning levels equal to or higher than his/her own learning level during execution of the display control. This enables the user U1 to refer to understanding, insights, and the like which are more helpful than in a case of referring to replies to the questionnaire of other users having learning levels lower than his/her own learning level, which can further improve the educational effect on the user U1.

In addition, although the embodiment is an example in which the results of replies to the questionnaire of the other users are displayed in descending order in the priority order during execution of the display control processing, the method of displaying the results of replies to the questionnaire is not limited to this. For example, during execution of the display control processing, a display area of a reply to the questionnaire given higher priority may be set to be larger than a display area of a reply to the questionnaire given lower priority. Alternatively, during execution of the display control processing, a display time period of a reply to the questionnaire given higher priority may be set to be longer than a display time period of a reply to the questionnaire given lower priority.

Further, although the embodiment is an example in which the learning quality is computed based on the result of answers (the percentage of correct answers and the answering time period) of the user U1 to test questions after a curriculum is terminated, instead of this, the learning quality may be computed by a technique which will be described below. For example, the learning quality may be computed based on states of selection and termination of the curriculum of the user U1.

On the other hand, although the embodiment is an example in which the processing of determining the priority order (STEP 46 in FIG. 7) is executed in the server 2, instead of this, the processing of determining the priority order may be executed in the terminal 3.

In addition, although the embodiment is an example in which content of a digital marketing course is used as e-learning content, instead of this, content of a course which will be described below may be used as the e-learning content.

For example, content such as a course on operations of various personal computer programs, a course on e-mail manners and rules, an information security course, a schedule management course, a course on English business e-mail and letters, or the like may be used.

Further, content such as a course on training for new employees, a course on business manners, a speech course, a course on negotiation skills, a legal course, or a course on financial statements may be used.

In addition, although the embodiment is an example in which the server 2 is used as the arithmetic processing device, instead of this, a supercomputer, cloud computing, or a personal computer may be used as the arithmetic processing device.

Further, although the embodiment is an example in which the terminals 3 and 4 of the smartphone type and of the desktop personal computer type are used as the terminals, instead of them, notebook PC type terminals, tablet PC type terminals, or the like may be used.

On the other hand, although the embodiment is an example in which replies to a questionnaire are used as the item information, the item information of the present invention is not limited to this, and should only include at least one of a reply of the individual terminal user to a questionnaire related to any single subject among a plurality of subjects in e-learning content and conducted when the single subject is terminated, an opinion of the individual terminal user about the single subject, and an impression of the individual terminal user about the single subject. For example, a user may enter an impression related to a curriculum in the terminal irrespective of a questionnaire, or may enter a question to content of the curriculum in the terminal. In such a case, the impression and question are equivalent to the item information.

In addition, although the embodiment is an example in which a descriptive questionnaire is used as a questionnaire to users, instead of this, a multiple-choice questionnaire may be used.

### REFERENCE SIGNS LIST

1 e-learning system
2 server (arithmetic processing device)
21 control unit (acquisition unit, priority order determination unit)
3 terminal
31 terminal control unit (display control unit)
33 display (display unit, input unit)
4 terminal
5 network
U1 user
U2 user

1. An e-learning system including an arithmetic processing device and a plurality of terminals that are able to communicate with the arithmetic processing device via a network, e-learning content including a plurality of subjects being offered from the arithmetic processing device to the plurality of terminals used by a plurality of respective users, the e-learning system comprising:
an acquisition unit provided in the arithmetic processing device, the acquisition unit being configured to acquire a learning quality indicating a quality of learning of the e-learning content of an individual terminal user who is each of the respective users using the plurality of terminals, an amount of learning of the e-learning content of the individual terminal user, and item information including at least one of a reply of the individual terminal user to a questionnaire related to any single subject among the plurality of subjects in the e-learning content and conducted when the single subject is terminated, an opinion of the individual terminal user about the single subject, and an impression of the individual terminal user about the single subject;
a priority order determination unit provided in one of the arithmetic processing device and each of the terminals, the priority order determination unit being configured to determine a priority order of the item information in accordance with the learning quality and the amount of learning of the individual terminal user acquired by the acquisition unit; and
a display control unit provided in each of the terminals, the display control unit being configured to execute display control of displaying the item information determined by the priority order determination unit on a display unit of each of the terminals in correspondence to the priority order.

2. The e-learning system according to claim 1, wherein the item information displayed on the display unit during execution of the display control is the item information of the users except a terminal user who is each of the users using the terminals, learning levels of the users except the terminal user determined based on the learning quality and the amount of learning falling within a predetermined range with respect to the learning level of the terminal user.

3. The e-learning system according to claim 1, wherein the item information displayed on the display unit during execution of the display control is the item information of the users except a terminal user who is each of the users using the terminals, learning levels of the users except the terminal user determined based on the learning quality and the amount of learning being equal to or higher than the learning level of the terminal user.

4. The e-learning system according to claim 1, wherein
the terminals are configured such that when an input unit of each of the terminals is operated by a terminal user who is each of the users using the terminals during execution of the display control, rating data including at least one of a comment of the terminal user on the item information of the users except the terminal user, a low rating, and a high rating can be entered, and
the priority order determination unit determines the priority order of the item information further in accordance with a total number of pieces of the rating data about the item information.

5. The e-learning system according to 3 claim 1, wherein the terminals are configured such that when an input unit of each of the terminals is operated by a terminal user who is each of the users using the terminals during execution of the display control, rating data including at least one of a comment of the terminal user on the item information of the users except the terminal user, a high rating, and a low rating can be entered, and a total number of pieces of the rating data entered by the plurality of users including the terminal user is displayed.

6. An e-learning method for offering e-learning content including a plurality of subjects from an arithmetic processing device to a plurality of terminals used by a plurality of respective users via a network, wherein
the arithmetic processing device executes communication with each of the plurality of terminals via the network to perform acquisition of a learning quality indicating a quality of learning of the e-learning content of an individual terminal user who is each of the respective users using the terminals, an amount of learning of the e-learning content of the individual terminal user, and item information including at least one of a reply of the individual terminal user to a questionnaire related to any single subject among the plurality of subjects in the e-learning content and conducted when the single subject is terminated, an opinion of the individual terminal user about the single subject, and an impression of the individual terminal user about the single subject,
one of the arithmetic processing device and each of the terminals determines a priority order of the item information in accordance with the learning quality and the amount of learning of the individual terminal user having been obtained by the acquisition, and
each of the terminals displays the item information in correspondence to the priority order.
